(19) United States
(12) Patent Application Publication
(10) Pub. No.: US 2008/0293907 A1
(43) Pub. Date: Nov. 27, 2008

(54) Method for Preparing Ss-Ketocarbonyl-Functional Organo-Silicium Compounds

(75) Inventors: Christian Herzig, Waging (DE); Martina Joachimbauer, Haiming (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/094,762

(22) PCT Filed: Nov. 14, 2006
(86) PCT No.: PCT/EP06/68421

§ 371 Date: May 22, 2008

(30) Foreign Application Priority Data
Nov. 24, 2005 (DE) 10 2005 056 051.2

(51) Int. Cl. C08G 77/04; C07F 7/02

(52) U.S. Cl. 528/10; 556/413

(57) ABSTRACT

β-ketocarbonyl-functional organosilicon compounds are prepared by reacting amino organo-functional organosilicon compounds with a diketene in the presence of a compound which inhibits the reaction of amine groups with β-ketocarbonyl compounds.

The invention relates to a process for preparing β-ketocarbonyl-functional organosilicon compounds.

U.S. Pat. No. 4,861,839 describes alkoxysilanes which are substituted by acetoacetic (thio)ester groups or acetoacetamido groups and are used as monomeric chelating ligands for metal catalysts.

Polymeric β-ketoestersiloxanes are known from U.S. Pat. No. 4,808,649, as is a process for preparing them and their use as stabilizer for polyvinyl chloride.

Functional polysiloxanes containing acetoacetate groups are described in U.S. Pat. No. 5,952,443, in which part of the functional groups has to contain at least two β-keto-carbonyl groups per functional group and the number of dimethylsiloxy units is not greater than 50. Crosslinking by means of polyamines in surface coating formulations is also described.

The modification of carbinolsiloxanes or aminopoly-siloxanes by means of diketene and its derivatives is described in U.S. Pat. No. 6,121,404. The products are used in aqueous solution together with aminopolysiloxanes for producing elastomer films.

It was an object of the invention to provide a process for preparing β-ketocarbonyl-functional organosilicon compounds which gives ungelled products. The object is achieved by the invention.

The invention provides a process for preparing β-keto-carbonyl-functional organosilicon compounds, in which diketenes (1) of the general formula

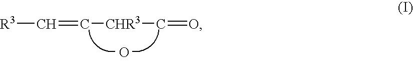

where
R³ is a hydrogen atom or a hydrocarbon radical having from 1 to 18 carbon atoms, preferably a hydrogen atom,
   are reacted with organosilicon compounds (2) which contain at least one Si-bonded radical A of the general formula

—R¹—NR²₂ (II)

per molecule, where
R¹ is a divalent organic radical which has from 2 to 10 carbon atoms and may contain heteroatoms selected from the group consisting of oxygen, sulfur and nitrogen, preferably a hydrocarbon radical having from 2 to 10 carbon atoms, more preferably from 2 to 4 carbon atoms,
R² is a hydrogen atom or an organic radical which has from 1 to 100 carbon atoms and may contain nitrogen atoms, preferably a hydrogen atom or an alkyl, cycloalkyl or aminoalkyl radical having from 1 to 30 carbon atoms,
   with the proviso that the radical of the formula (II) has at least one primary amino group and, if appropriate, at least one secondary amino group, preferably at least one primary amino group,
   in the presence of organic compounds (3) which retard or prevent the reaction of primary or secondary amino groups with β-ketocarbonyl compounds.

Preference is given to using diketene of the formula

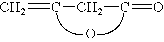

As organosilicon compounds (2), it is possible to use silanes or oligomeric or polymeric organopolysiloxanes. The organosilicon compounds (2) preferably contain from 1 to 20000 Si atoms, more preferably from 2 to 5000 Si atoms and particularly preferably from 60 to 3000 Si atoms. The organosilicon compounds (2) can be linear, branched, dendritic or cyclic and can also contain polymeric organic groups such as polyether, polyester or polyurea groups.

Organopolysiloxanes comprising units of the general formula

$${A}_{a} {{R}_{c} ( {O R}^{4} )}_{d} {SiO}_{\frac{4 - ( a + c + d )}{2}} \qquad ( III )$$

where
A is a radical of the general formula —R¹—NR²₂ (II), where R¹ and R² are as defined above,
R is a monovalent, substituted or unsubstituted hydrocarbon radical having from 1 to 18 carbon atoms per radical,
R⁴ is a hydrogen atom or an alkyl radical having from 1 to 8 carbon atoms, preferably a hydrogen atom or a methyl or ethyl radical,
a is 0 or 1,
c is 0, 1, 2 or 3 and
d is 0 or 1,
   with the proviso that the sum a+c+d is ≦3 and on average at least one radical A is present per molecule, are preferably used as organosilicon compounds (2).

Preferred examples of organosilicon compounds (2) are organopolysiloxanes of the general formulae

AgR^{3-g}SiO(SiR₂O)₁(SiRAO)ₖSiR_{3-g}A_{g} (IVa) and

(R⁴O)R₂SiO(SiR₂O)ₙ(SiRAO)ₘSiR₂(OR⁴) (IVb)

where A, R and R⁴ are as defined above,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical A is present per molecule.

Further examples of organosilicon compounds (2) are organopolysiloxanes comprising units of the general formulae

$$\begin{matrix}{A SiO}_{3 / 2} \\ and & ( Va ) \\ {R}_{e} {SiO}_{\frac{4 - e}{2}} , & ( Vb )\end{matrix}$$

organopolysiloxanes comprising units of the general formulae

$$\begin{matrix}{AR}_{2} {SiO}_{1 / 2} \\ and & ( Vc ) \\ {R}_{f} {SiO}_{\frac{4 - f}{2}} ( Vd ) , & ( Vd )\end{matrix}$$

and organopolysiloxanes comprising units of the general formulae

$$\begin{matrix}AR SiO ( Ve ) \\ and & ( Ve ) \\ {R}_{f} {SiO}_{\frac{4 - f}{2}} ( Vf ) , & ( Vf ) \\ {R}_{2} SiO ( Vg ) , & ( Vg )\end{matrix}$$

where A and R are as defined above,
e is 1, 2 or 3 and
f is 0 or 1.

The organosilicon compounds (2) used in the process of the invention preferably have a viscosity of from 1 mPa·s to 1000000 mPa·s at 25° C., preferably from 100 mPa·s to 50000 mPa·s at 25° C.

Examples of radicals R are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-tri-methylpentyl radical, nonyl radicals such as the n-nonyl radical, decyl radicals such as the n-decyl radical, dodecyl radicals such as the n-dodecyl radical and octadecyl radicals such as the n-octadecyl radical; cycloalkyl radicals such as cyclopentyl, cyclohexyl, cycloheptyl and methylcyclohexyl radicals; alkenyl radicals such as the vinyl, 5-hexenyl, cyclohexenyl, 1-propenyl, allyl, 3-butenyl and 4-pentenyl radicals; alkynyl radicals such as the ethynyl, propargyl and 1-propynyl radicals; aryl radicals such as the phenyl, naphthyl, anthryl and phenanthryl radicals; alkaryl radicals such as o-, m-, p-tolyl radicals, xylyl radicals and ethylphenyl radicals; and aralkyl radicals such as the benzyl radical, the α- and β-phenylethyl radicals.

Examples of radicals R¹ are —CH₂CH₂—, —CH(CH₃)—, —CH₂CH₂CH₂—, —CH₂C(CH₃)H—, —CH₂CH₂CH₂CH₂—, —CH₂CH₂CH(CH₃)—, with the —CH₂CH₂CH₂-radical being preferred.

Examples of hydrocarbon radicals R also apply to hydrocarbon radicals R².

Further examples of R² are hydrogen and N-containing radicals such as —CH₂CH₂NH₂, —CH₂CH₂NHCH₃, —CH₂CH₂N(CH₃)₂, —CH₂CH₂CH₂NH₂, —CH₂CH₂CH₂N(CH₃)₂.

Examples of hydrocarbon radicals R also apply to hydrocarbon radicals R³.

Examples of alkyl radicals R⁴ are alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical.

A preferred radical A is the radical of the general formula

—R¹—NH—(CH₂)₂—NH₂ (VIa),

where R¹ is as defined above, and a particularly preferred radical A is the radical of the formula

—(CH₂)₃—NH—(CH₂)₂—NH₂ (VIb).

As organic compounds (3), preference is given to using those which form more or less solid adducts with amines. It is possible to use one type of compound (3) or a plurality of types of compounds (3). Examples of compounds (3) are aldehydes and ketones. Preferred examples are acetone, butanone, methyl isobutyl ketone and cyclohexanone.

In the process of the invention, preference is given to firstly mixing the organosilicon compound (2) with the organic compound (3) and then adding the diketene (1).

In the process of the invention, preference is given to reacting organosilicon compounds (2) with organic compounds (3), with the compounds (3) forming protective groups on the amino groups in the radical A of the formula (II), in a 1^{st} stage and subsequently reacting the organosilicon compounds (2) having the protected amino groups (reaction products of (2) and (3)) obtained in the 1^{st} stage with diketenes (1) in a 2^{nd} stage.

In the reaction with diketene, the protective group is surprisingly split off from the amino group in the radical A of the formula (II) again.

If ketones are used as compounds (3), these react preferentially with the primary amino groups. This reaction is preferably carried out at from 0 to 90° C., particularly preferably from 10 to 60° C.

The condensation reaction in the 1^{st} stage leads to an equilibrium state which is far on the side of the reaction products of (2) and (3), so that only very few primary amino groups are still present.

Products formed by the condensation in the 1^{st} stage are the reaction product of (2) and (3) and also water which is required later for regenerating free amino groups after addition of diketene. It has been found that the few amino groups present in the equilibrium react with diketene to form β-ketoamides, whereupon an equilibrium is reestablished and small amounts of free amino groups are therefore continually formed. Secondary reactions are surprisingly avoided virtually entirely as a result of these low amine concentrations. The water of condensation can be left in the mixture, be bound reversibly or be removed. If water is bound reversibly, it has to be set free again by means of suitable measures after introduction of diketene (1). In the case of physical absorption, this can usually be effected by heating. However, if water is removed from the reaction mixture, it has to be added again in at least the same amount after introduction of diketene so that the reaction of diketene with the amino groups can proceed to completion.

The water of condensation can be reversibly bound to absorbents which can take up water. Examples are zeolites and molecular sieves having pore sizes of 3 or even 4 Å. Water of condensation can also be bound as “water of crystallization” in inorganic salts such as sodium sulfate or magnesium sulfate used in anhydrous form. Reversibly bound water can be set free again by heating the reaction mixture to a suitable temperature and can thus be made available again for the regeneration of free primary or secondary amino groups.

Water of condensation can be removed completely from the reaction mixture if the absorbents are removed, e.g. by filtration, or these bind water so strongly that it can no longer be set free by methods which are compatible with the reaction. Permanent removal of water can also be effected by means of reduced pressure. In all these cases, renewed addition of water is necessary after the addition of diketene. It can be introduced quickly, slowly or in portions.

The organic compounds (3) used in the process of the invention can remain in the product or else be removed, for example by distillation under reduced pressure or by extraction.

The organic compound (3) is used in amounts of preferably at least 1 mol, more preferably at least 1.5 mol, in particular from 1 to 10 mol, particularly preferably from 1.5 to 5 mol, per mole of amino group (primary and secondary) in the radical A of the general formula (II) in the organosilicon compound (2).

In the process of the invention, diketene (1) is used in amounts of preferably from 0.5 to 1.5 mol, more preferably from 0.7 to 1.2 mol, particularly preferably from 0.9 to 1.1 mol, per mole of amino group (primary and secondary) in the radical A of the general formula (II) in the organosilicon compound (2).

A particular embodiment of the invention comprises the use of equimolar amounts of diketene and amino groups.

The process of the invention is preferably carried out at temperatures of from −20 to 120° C., preferably from 0 to 90° C. Particular preference is given to the temperature range from 10 to 60° C. Furthermore, the process of the invention is preferably carried out at the pressure of the surrounding atmosphere, but can also be carried out at higher and lower pressures.

The β-ketocarbonyl-functional organosilicon compounds obtained by the process of the invention preferably contain at least one Si-bonded radical B containing a group of the general formula

—N(-Z)- (VII)

where
Z is a radical of the formula —C(═O)—CHR³—C(═O)—CH₂R³ per molecule.

The β-ketocarbonyl-functional organosilicon compounds obtained are preferably ones which contain, as Si-bonded radicals B, at least one radical of the general formula

—R¹—NH(-Z) (VIII)

or

—R¹—NH₁₋ₓ(-Z)ₓ-(CH₂)₂—NH(-Z) (IX),

where Z is as defined above and
x is 0 or 1,
per molecule, with the radical of the formula (IX) being particularly preferred.

A particularly preferred radical B is the radical of the formula

—(CH₂)₃—NH₁₋ₓ(-Z)ₓ-(CH₂)₂—NH(-Z) (X)

where Z is as defined above.

The invention therefore provides β-ketocarbonyl-functional organosilicon compounds which contain at least one Si-bonded radical of the general formula

—R¹—NH₁₋ₓ(-Z)ₓ-CH₂CH₂—NH(-Z) (IX)

where Z is as defined above and
x is 0 or 1,
per molecule.

The β-ketocarbonyl-functional organosilicon compounds obtained are preferably organopolysiloxanes comprising units of the general formula

$${B}_{a} {{R}_{c} ( {O R}^{4} )}_{d} {SiO}_{\frac{4 - ( a + c + d )}{2}} \qquad ( XI )$$

where B, R, R⁴, a, c and d are as defined above, with the proviso that the sum of a+c+d is ≦3 and on average at least one radical B is present per molecule.

Preferred examples of β-ketocarbonyl-functional organosilicon compounds are organopolysiloxanes of the general formulae

B_{g}R_{3-g}SiO(SiR₂O)₁(SiRBO)ₖSiR_{3-g}B_{g} (XIIa) and

(R⁴O)R₂SiO(SiR₂O)ₙ(SiRBO)ₘSiR₂(OR⁴) (XIIb)

where B, R and R⁴ are as defined above,
g is 0 or 1,
k is 0 or an integer from 1 to 30 and
l is 0 or an integer from 1 to 1000,
m is an integer from 1 to 30 and
n is 0 or an integer from 1 to 1000,
with the proviso that on average at least one radical B is present per molecule.

Further examples of β-ketocarbonyl-functional organosilicon compounds are

organopolysiloxanes comprising units of the general formulae

$$\begin{matrix}{B SiO}_{3 / 2} and & ( XIIIa ) \\ {R}_{e} {SiO}_{\frac{4 - e}{2}} , & ( XIIIb )\end{matrix}$$

organopolysiloxanes comprising units of the general formulae

$$\begin{matrix}{BR}_{2} {SiO}_{1 / 2} and & ( XIVa ) \\ {R}_{f} {SiO}_{\frac{4 - f}{2}} , & ( XIVb )\end{matrix}$$

and organopolysiloxanes comprising units of the general formulae

$$\begin{matrix}BR SiO and & ( XVa ) \\ {R}_{f} {SiO}_{\frac{4 - f}{2}} , & ( XVb ) \\ {R}_{2} SiO & ( XVc )\end{matrix}$$

where B, R, e and f are as defined above.

The β-ketocarbonyl-functional organosilicon compounds obtained in the process of the invention preferably have a viscosity of from 10 mPa·s to 10000000 mPa·s at 25° C., preferably from 100 mPa·s to 500000 mPa·s at 25° C.

The β-ketocarbonyl-functional organosilicon compounds of the invention can be used:
a) for fixing silicon compounds/siloxanes on surfaces containing amine groups, which can be controlled as a result of the pH dependence
b) for forming polymers (linear, branched) by means of reaction partners containing amine groups through to crosslinking, in which they function, depending on the functionality density, as crosslinkers or as polymers to be crosslinked
c) for fixing on substrates containing metal ions, in which case the metal ions bind to the products according to the invention with chelate formation and the bond strength depends on the type of ion,
d) for crosslinking by means of polyacrylates by Michael addition.

### EXAMPLE 1

269 g of a dimethylpolysiloxane having 3-(aminoethyl-amino)propyl end groups and an amine content of 0.78 meq./g are mixed with 24.4 g of acetone at 22° C. After about 4 hours, a total of 17.7 g of diketene is introduced at a uniform rate and with good stirring over a period of about 1 minute. A slightly exothermic reaction occurs and the viscosity of the amine oil increases significantly. The mixture is allowed to react further for another 2 hours without external heating and the acetone added is removed at 70° C. under reduced pressure. This gives a clear, yellowish oil having a viscosity of 1800 mm²/s (25° C.). The ¹H-NMR spectrum shows a keto/enol ratio of the β-ketoamido-siloxane formed of 5.0; the amine conversion is quantitative (>99%).

### EXAMPLE 2

136.5 g of a commercial aminosiloxane composed of 3-(aminoethylamino)propylmethylsiloxy and dimethyl-siloxy units and methoxy end groups and having an amine content of 0.293 meq./g at a viscosity of 980 mm²/s are stirred with 4.7 g of acetone at 25° C. for 4 hours. This is followed by addition of 3.7 g of diketene, resulting in a slight increase in temperature. After a further 2 hours, the acetone is removed at 70° C. under reduced pressure. This gives a clear, yellowish oil having a viscosity of 4900 mm²/s (25° C.). The ¹H-NMR spectrum shows quantitative amine conversion. The β-ketoamidosiloxane has a keto/enol ratio of 3.0. Both the primary amino groups and the secondary amino groups have been acetoacylated.

Comparative Experiment in Accordance with U.S. Pat. No. 6,121,404:

Example 2 is carried out without addition of acetone, i.e. without compound (3), which has a conditioning effect on amino groups. The addition of diketene likewise leads to an exothermic reaction, but the increase in viscosity is substantially greater. After about 5 minutes, the mixture becomes inhomogeneous. A partially gelled product which is only partly soluble in toluene is obtained. A viscosity can no longer be measured.

### EXAMPLE 3

To test the controllability of the derivatization of the amine oil by means of diketene, a significantly more viscous aminopolysiloxane is used. Thus, 174.8 g of a commercial aminopolysiloxane having structural elements identical to those of the starting material of example 2 but having a viscosity of 5200 mm²/s (25° C.) and an amine content of 0.143 meq./g are stirred with 2.9 g of acetone at 25° C. for 4 hours. The subsequent addition of 2.3 g of diketene results in a slightly exothermic reaction and an increase in viscosity. After 2 hours and removal of the acetone at 70° C. under reduced pressure, a clear yellowish oil having a viscosity of 16000 mm²/s (25° C.) is obtained. The ¹H-NMR spectrum shows no remaining amine; the keto/enol ratio is 3.7. Both primary amino groups and secondary amino groups were acetoacylated.

1-20. (canceled)

21. A process for preparing β-ketocarbonyl-functional organosilicon compounds, comprising reacting diketenes (1) of the formula 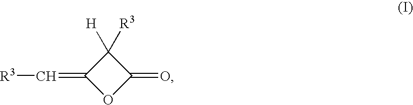
where
R³ is a hydrogen atom or a hydrocarbon radical having from 1 to 18 carbon atoms, with organosilicon compounds (2) which contain at least one Si-bonded radical A of the formula
—R¹—NR²₂ (2)
where
R¹ is a divalent organic radical which has from 2 to 10 carbon atoms, optionally containing one or more heteroatoms selected from the group consisting of oxygen, sulfur and nitrogen,
R² is a hydrogen atom or an organic radical which has from 1 to 100 carbon atoms and optionally contains nitrogen atom(s),
with the proviso that the radical A of the formula (II) has at least one primary amino group and optionally one or more secondary amino groups,
the reaction taking in the presence of organic compounds (3) which retard or prevent the reaction of primary or secondary amino groups with β-ketocarbonyl compounds.

22. The process of claim 21, wherein organosilicon compounds (2) are reacted with organic compounds (3) in a 1^{st} stage, and in a 2^{nd} stage, diketenes (1) are added to the reaction products of (2) and (3) obtained in the 1^{st} stage.

23. The process of claim 22, wherein water is liberated in the 1^{st} stage, is bound reversibly, and is set free again after addition of diketene (1).

24. The process of claim 22, wherein water is liberated in the 1^{st} stage, is removed from the reaction mixture, and is added again after addition of diketene (1).

25. The process of claim 21, wherein one or more aldehydes or ketones are used as organic compounds (3).

26. The process of claim 21, wherein one or more compounds selected from the group consisting of acetone, butanone, methyl isobutyl ketone and cyclohexanone are used as organic compounds (3).

27. The process of claim 21, wherein the organic compound (3) is used in an amount of at least 1 mol per mol of primary and secondary amino groups in the radical A of the formula (II) in the organosilicon compound (2).

28. The process of claim 21, wherein the organic compound (3) is used in an amount of at least 1.5 mol per mol of primary and secondary amino groups in the radical A of the formula (II) in the organosilicon compound (2).

29. The process of claim 21, wherein diketene (1) is used in an amount of from 0.7 to 1.2 mol per mol of primary and secondary amino groups in the radical A of the formula (II) in the organosilicon compound (2).

30. The process of claim 21, wherein diketene (1) is used in an amount of from 0.9 to 1.1 mol per mol of primary and secondary amino groups in the radical A of the formula (II) in the organosilicon compound (2).

31. The process of claim 21, wherein the process is carried out at a temperature of from −20° C. to 120° C.

32. The process of claim 21, wherein R³ is a hydrogen atom.

33. The process of claim 21, wherein R¹ is a divalent hydrocarbon radical having from 2 to 10 carbon atoms.

34. The process of claim 21, wherein R² is a hydrogen atom or an alkyl, cycloalkyl or aminoalkyl radical.

35. The process of claim 21, wherein the radical A is a radical of the formula
—R¹—NH—(CH₂)₂—NH₂ (VIa).
